(19) United States
(12) Patent Application Publication
(10) Pub. No.: US 2009/0108545 A1
(43) Pub. Date: Apr. 30, 2009

(54) SPIN CHUCK

(75) Inventors: Oh-Jin Kwon, Chungcheongnam-do (KR); Jeong-Yong Bae, Chungcheongnam-do (KR); Jeong-Yeol Choi, Chungcheongnam-do (KR)

Correspondence Address: CHARTER IP, LLC, P.O. BOX 64, The Plains, VA, 20198, US

(73) Assignee: SEMES, CO., LTD.

(21) Appl. No.: 12/091,743

(22) PCT Filed: Oct. 26, 2006
(86) PCT No.: PCT/KR2006/004386

§ 371 Date: Aug. 25, 2008

(30) Foreign Application Priority Data
Oct. 26, 2005 (KR) 10-2005-0101320

(51) Int. Cl. B23B 31/12

(52) U.S. Cl. 279/106

(57) ABSTRACT

The present invention is directed to a spin chuck for use in a process, such as a cleaning process and an etching process, performed while rotating a substrate. The spin chuck includes a spin head on which a substrate is placed, a driving part configured to rotate the spin head, and a fix bracket installed on the spin head and having a contact surface that is in contact with a flat surface of a flat zone of the substrate at a position corresponding to the flat zone to prevent a vortex caused by the flat zone. Since the fix bracket has the same shape as the flat zone of the substrate, an air current unbalance resulting from the flat zone is suppressed to uniformly inject etchants to a rear surface of the substrate.

### TECHNICAL FIELD

The present invention relates to apparatuses for manufacturing semiconductor devices. More specifically, the present invention is directed to a spin chuck for use in processes, such as a cleaning process and an etching process, performed while rotating a substrate.

### BACKGROUND ART

A multi-layer thin film is formed on a semiconductor substrate to manufacture a semiconductor device. In general, an etching process is necessarily adopted in the formation of the multi-layer thin film. Since thin films deposited on a rear surface of a semiconductor substrate act as foreign substances in subsequent processes, an etching process is also performed for the rear surface of a semiconductor substrate by means of a single-wafer etching apparatus to remove the foreign substances.

In a conventional spin chuck for use in an etching process for a rear surface of a semiconductor substrate, a spinning force caused by a spin motor is transmitted to spindle around a through-hole axis by means of a belt to rotate a spin head. Etchants are injected to the rear surface of a semiconductor substrate through a back nozzle installed at the spin head to etch the rear surface of a semiconductor substrate.

While no problem occurs when a conventional single wafer etching apparatus treats a substrate with a notch, several problems may occurs when the conventional single wafer etching apparatus treats a substrate with a flat zone (generally, 200 mm substrate). The problems are as follows: (1) an etching uniformity of a rear surface of a substrate decreases due to an air current unbalance caused by a flat zone of the substrate; and (2) etchants flowing from a back nozzle penetrate into a pattern-formed top surface from a flat zone of a substrate to damage patterns adjacent to the flat zone.

### DISCLOSURE OF INVENTION

### Technical Problem

An exemplary embodiment of the present invention provides a spin chuck for reducing an air current unbalance.

Another exemplary embodiment of the present invention provides a spin chuck for enhancing an etching uniformity of a rear surface of a substrate.

Another exemplary embodiment of the present invention provides a spin chuck for preventing etchants flowing from a back nozzle from penetrating into a pattern-formed top surface of a substrate.

### Technical Solution

In an exemplary embodiment, the spin chuck may include a rotatable spin head on which a substrate is placed; a driving unit configured to rotate the spin head; spindle configured to connect the driving unit with the spin head; and a fix bracket installed on the spin head and including a contact surface that is in contact with a flat surface of a flat zone of the substrate at a position corresponding to the flat zone to prevent a vortex caused by the flat zone.

In an exemplary embodiment, the spin chuck may include a rotatable spin head on which a substrate having the edge with flat surfaces is placed; a driving unit configured to rotate the spin head; spindle configured to connect the driving unit with the spin head; and fix brackets installed on the upper edge of the spin head to complement a shape of the substrate, wherein each of the fix brackets includes a plate with a contact surface that is in contact with a flat surface of the substrate.

### ADVANTAGEOUS EFFECTS

According to the present invention, a spin chuck includes a fix bracket having the same shape as a flat zone of s substrate to prevent an air current unbalance caused by the flat zone. Thus, etchants are uniformly injected to a rear surface of the substrate to enhance an etch uniformity of the rear surface, especially, to prevent the etchants injected to the rear surface of the substrate from penetrating into a top surface of the substrate from the flat zone.

### BRIEF DESCRIPTION OF THE DRAWINGS

FIG. 1 illustrates a single-wafer etching apparatus with a spin chuck for spinning a substrate according to the present invention.

FIG. 2 and FIG. 3 are a top plan view and a cross-sectional view of the spin chuck illustrated in FIG. 1, respectively.

FIG. 4 illustrates a single-wafer etching apparatus with a spin chuck for spinning an LCD substrate according to the present invention.

FIG. 5 is a top plan view of the spin chuck illustrated in FIG. 4.

FIG. 6 and FIG. 7 are enlarged views of principal parts, illustrating the travel of a fix bracket, respectively.

### BEST MODE FOR CARRYING OUT THE INVENTION

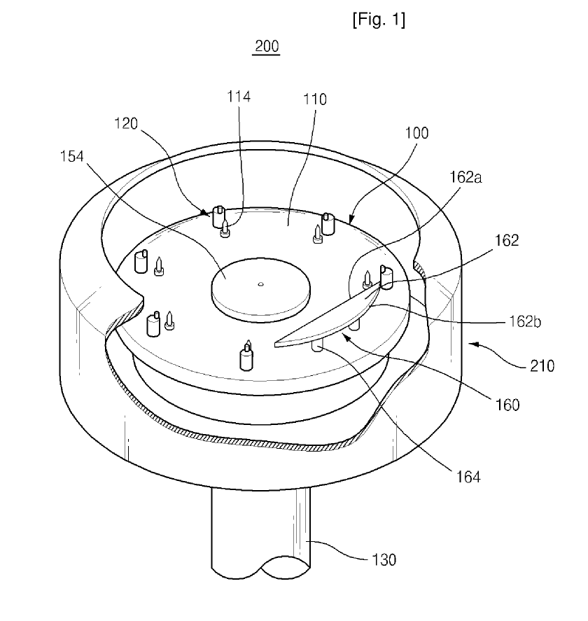

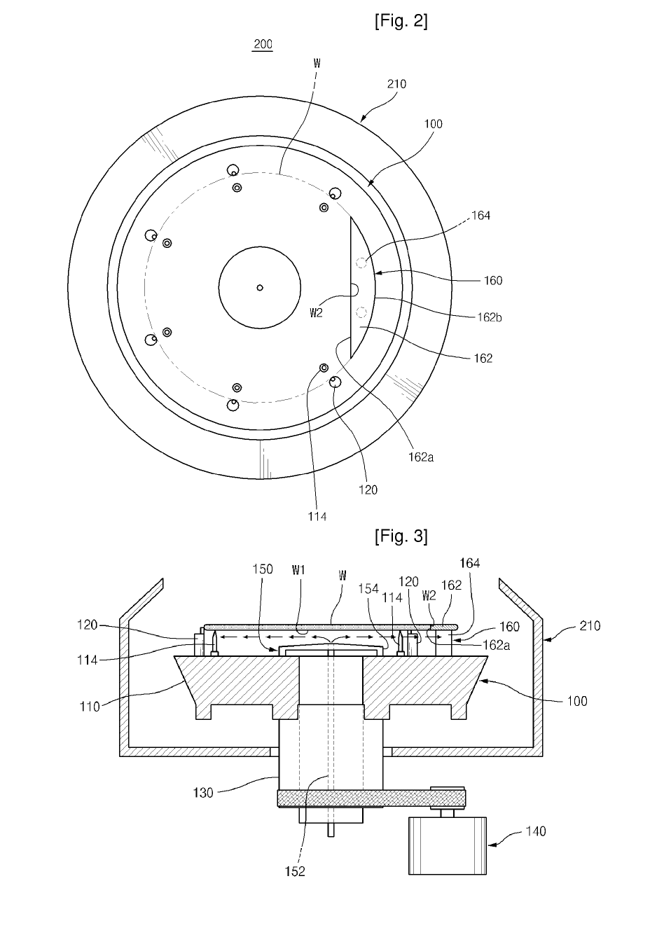

FIG. 1 illustrates a spin chuck 100 according to an embodiment of the present invention. FIG. 2 and FIG. 3 are a top plan view and a cross-sectional view of the spin chuck 100, respectively.

Referring to FIG. 1, the spin chuck 100 may be applied to a single-wafer etching apparatus 200 for etching a rear surface of a substrate W. Since the single-wafer etching apparatus 200 uses acid solution (hereinafter referred to as etchant) to remove predetermined layers formed on the surface of a substrate, a vessel 210 is disposed around the spin chuck 100 to protect surrounding units. A variety of units (not shown) may be provided around the vessel 210 to etch a substrate held by the spin chuck 100 inside the vessel 210.

According to the single-wafer etching process 200, an etching process is carried out for a rear surface of a substrate while spinning the substrate using the spin chuck 100.

The configuration of the spin chuck 100 will now be described below more fully with reference to FIG. 1 through FIG. 3.

The spin chuck 100 includes a spin head 110 on which a substrate W is placed. A plurality of chucking pins 120 are installed at the edge of a top surface 112 of the spin head 110. The chucking pins 120 are spaced at regular intervals and protrude upwardly. A plurality of support pins 114 are installed inside the chucking pins 120.

Similar to the chucking pins 120, the support pins are spaced at regular intervals and protrude upwardly. The support pins 114 are provided to support a rear surface W1 of the substrate W, and the chucking pins 120 are provided to prevent the substrate W from dropping out from the spin head 110 due to the centrifugal force. The substrate W is fixed by the chucking pins 120, which are fixing members installed at the spin head 110, while being supported by the support pins 114 of the spin head 110. A rear surface edge and a lateral surface of the substrate W is fixed or unfixed by means of an eccentric spinning operation of the chucking pin 120.

The spin head 110 is coupled with spindle 130 which are hollow shafts for transmitting a spinning force of a spin motor 140 of a driving unit to the spin head 110. A back nozzle unit 150 includes a supply pipe 152 and a nozzle 154. The supply pipe 152 is a path of etchants passing the hollow sections of the spindle 130, and the nozzle 154 is installed at the center of a top surface of the spin head 110. The nozzle 154 is connected to the supply pipe 152 to be exposed to the center portion of the spin head 110, injecting etchants into the rear surface W1 to etch the rear surface W1. The supply pipe 152 may be a predetermined pipe or a hollow pipe-type space defined inside the spindle 130. The etchants injected to the center portion of the rear surface W1 through the nozzle 154 are readily injected to the edge of the substrate W by rotating the substrate W.

A fix bracket 160 is the most important thing of the components constituting the spin chuck 100 according to the present invention. The fix bracket 160 is mounted on the spin head 110 to prevent a vortex caused by a flat zone W2 of the rotating substrate W. The fix bracket 160 is disposed at the position corresponding to the flat zone W2 and includes a plate 162 and a base 164 configured to support the plate 162 from a top surface 112 of the spin head 110. The plate 162 includes a contact surface 162a that is in contact with a flat surface W2a of the flat zone W2 and a curved surface 162b having the same circumference as the substrate W and having the same shape as the flat zone W2. The plate 162 has the same thickness as the substrate W. The plate 162 is supported by the base 164 to have the same height as the substrate W from the top surface 112 of the spin head 110. A shape of the plate 162 is variable with shape and size of the flat zone W2 of the substrate W placed on the spin head 110. The above-configured fix bracket 160 is disposed at the flat zone W2 of the substrate W placed on the spin head 110, enabling the substrate W to take a perfect circle shape.

When the substrate W is placed on the spin head 110, the fix bracket 160 is disposed at the flat zone W2 of the substrate W to enable the substrate W to take a perfect circle shape. Thus, when the substrate W rotates at a high speed, the spin chuck 100a makes it possible to suppress the generation of turbulence between the rear surface (or top surface) W1 of the substrate W and the top surface 112 of the spin head 110 and to prevent unbalance of an air current at the rear surface W1 of the substrate W.

Especially, etchants injected to the rear surface W1 of the substrate W through the nozzle 154 of the back nozzle unit 150 spread to the edge from the center portion of the rear surface W1. Conventionally, the etchants spreading around a flat zone flow up to the top surface of the substrate W. However, the fix bracket 160 according to the invention is configured to prevent the etchants from flowing up thereto. It is noted that a substrate is a semiconductor substrate with a flat zone.

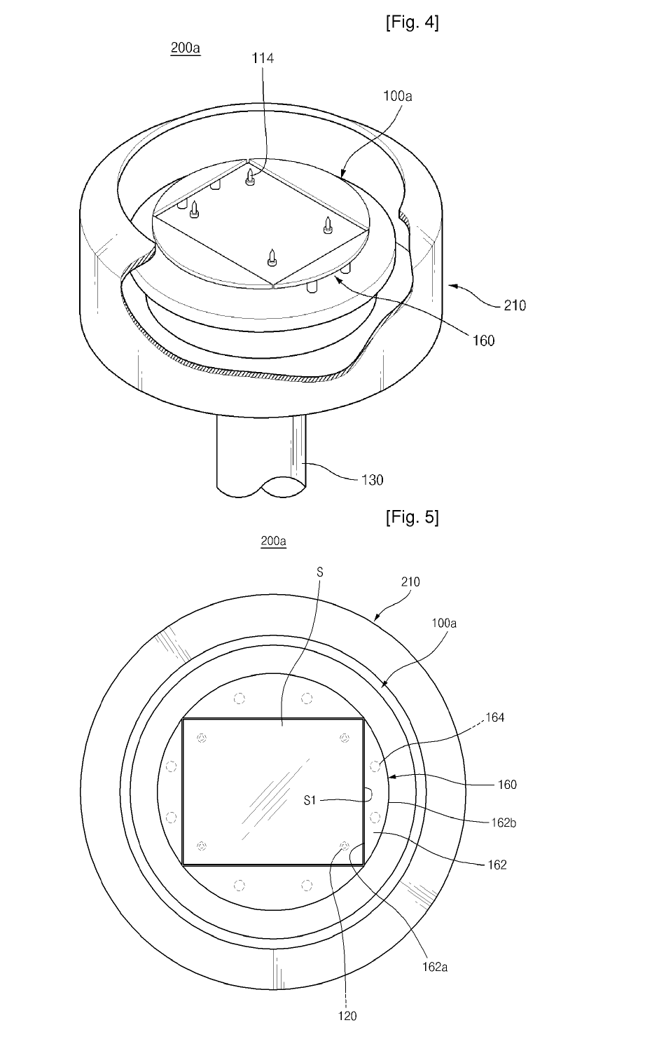

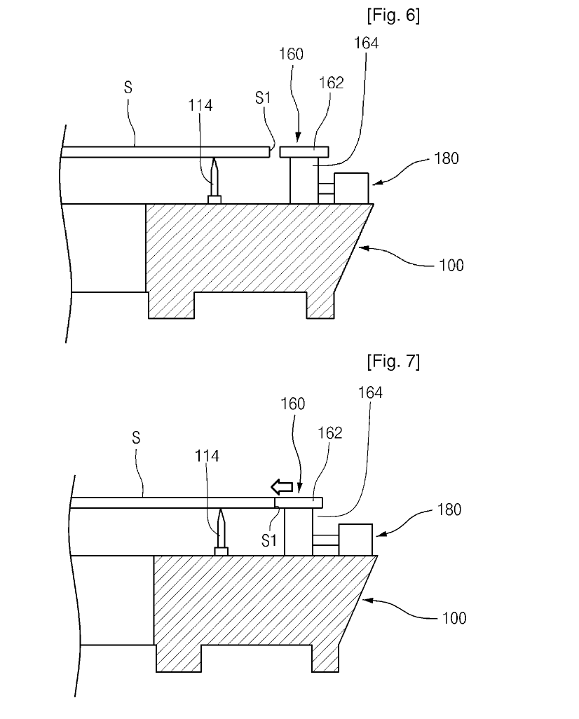

FIG. 4 illustrates a single-wafer etching apparatus 200a with a spin chuck 100a for spinning an LCD substrate according to a modified embodiment of the present invention. FIG. 5 is a top plan view of the spin chuck 100a illustrated in FIG. 4. FIG. 6 and FIG. 7 are enlarged views of principal parts, illustrating the travel of a fix bracket, respectively.

Referring to FIG. 4 and FIG. 5, the spin chuck 100a may be used in the single-wafer etching apparatus 200a for etching a surface of an LCD substrate S with four flat zones. However, the present invention may be applied to any apparatus for treating an LCD substrate with liquidus or gaseous processing fluid (e.g., a chemical coating apparatus, a developing apparatus, etc.). While a single-wafer etching apparatus for use in a rotary etching has been described in a preferred embodiment, the embodiment is not limited to etching apparatuses.

The single-wafer etching apparatus 200a has the same configuration and functions as the above-described single-wafer etching apparatus 200. However, in this modified embodiment, a processing-target object is an LCD substrate S of a rectangular plate. For this reason, four fix brackets 160 are provided at the spin chuck 100a.

The LCD substrate S is supported by means of support pins 114 installed at a top surface 112 of the spin head 110. The supported LCD substrate S is fixed by means of the four fix brackets 160 installed at the edge of the spin head 110. As illustrated in FIG. 6 and FIG. 7, edge flat surfaces S1 of an LCD substrate S may be fixed or unfixed by back-and- forth travel of a fix bracket 160. Fix brackets 160 travel back and fourth by means of a cylinder driver unit 180.

The fix brackets 160, which are most important components in the present invention, are installed at the upper edge of the spin head 110 to suppress a vortex resulting from the flat surfaces SI of a rotating LCD substrate S. These fix brackets 160 are disposed at positions corresponding to the flat surfaces SI of the LCD substrate S, respectively. A plate 162 of the fix bracket 160 includes a contact surface 162a that is in contact with the flat surface SI of the LCD substrate S and a curved surface 162b. Further, the plate 162 of the fix bracket 160 takes a shape to complementarily allow the LCD substrate S to take a perfect circle shape. The plate 162 of the fix bracket 160 has the same thickness as the LC substrate S and is supported by a base 164 to have the same height as the LCD substrate S from a top surface 112 of the spin head 110. A shape of the plate 162 is variable with shape and size of the flat surface SI of the LCD substrate S placed on the spin head 110. The above-configured fix brackets 160 are disposed at the flat surface SI of the LCD substrate S placed on the spin head 110, enabling the LCD substrate S to take a perfect circle shape.

When the LCD substrate S is placed on the spin head 110, the fix brackets 160 are disposed at the flat zone SI of the LCD substrate S to enable the LCD substrate S to take a perfect circle shape. Thus, when the LCD substrate S rotates at a high speed, the spin chuck 100a makes it possible to suppress the generation of turbulence between the rear surface (or top surface) SI of the LCD substrate S and the top surface 112 of the spin head 110 and to prevent unbalance of an air current at the rear surface SI of the LCD substrate S.

It is noted that an LCD substrate may be a rectangular plate substrate for use in a flat panel display such as a plasma display panel (PDP), a field emission display (FED), and an organic light emitting device (OLED).

Although the present invention has been described in connection with the embodiment of the present invention illustrated in the accompanying drawings, it is not limited thereto. It will be apparent to those skilled in the art that various substitutions, modifications and changes may be made without departing from the scope and spirit of the invention.

### INDUSTRIAL APPLICABILITY

The present invention is advantageous in various substrate treating processes performed while supporting and rotating a substrate.

1. A spin chuck comprising:
a rotatable spin head on which a substrate is placed;
a driving unit configured to rotate the spin head;
spindle configured to connect the driving unit with the spin head; and
a fix bracket installed on the spin head and including a contact surface that is in contact with a flat surface of a flat zone of the substrate at a position corresponding to the flat zone to prevent a vortex caused by the flat zone.

2. The spin chuck of claim 1, wherein the fix bracket takes the same shape as the flat zone of the substrate.

3. The spin chuck of claim 2, wherein the fix bracket further includes a curved surface having the same circumference as the substrate such that the substrate take a perfect circle shape when the substrate is placed on the spin head.

4. The spin chuck of claim 3, wherein the fix bracket has the same thickness as the substrate.

5. The spin chuck of claim 2, wherein the spin chuck further includes fixing members installed at the upper edge of the spin head to fix the lower edge and the side of the substrate.

6. The spin chuck of claim 5, wherein the spin chuck further includes a back nozzle unit installed rotatably inside the spindle to inject chemicals to a rear surface of the substrate.

7. A spin chuck comprising:
a rotatable spin head on which a substrate having the edge with flat surfaces is placed;
a driving unit configured to rotate the spin head;
spindle configured to connect the driving unit with the spin head; and
fix brackets installed on the upper edge of the spin head to complement a shape of the substrate,
wherein each of the fix brackets includes a plate with a contact surface that is in contact with a flat surface of the substrate.

8. The spin chuck of claim 7, wherein the plate of the fix bracket includes the edge with a curved surface such that the substrate takes a circle shape when the substrate is
placed on the spin head.

9. The spin chuck of claim 7, wherein the plate of the fix bracket has the same thickness as the substrate.

10. The spin chuck of claim 9, wherein the fix bracket further includes a base configured to support the plate from a top surface of the spin head such that the plate of the fix bracket is collinearly disposed at a position where the substrate is placed.

11. The spin chuck of claim 7, further comprising:
a back nozzle unit installed rotatably inside the spindle to inject chemicals to a rear surface of the substrate.

12. The spin chuck of claim 7, wherein the substrate is a rectangular plate substrate for use in a plasma display panel (PDP), a liquid crystal display (LCD), a field emission display (FED), and an organic light emitting device (OLED).
